(19) United States
(12) Patent Application Publication
(10) Pub. No.: US 2026/0312455 A1
(43) Pub. Date: Oct. 8, 2026

(54) Clamping device for a stator

(71) Applicant: Hilti Aktiengesellschaft, Schaan (LI)

(72) Inventors: Torsten ASMUS, Kaufbeuren (DE); Thomas MAHLER, Laage (DE); Christian RUFF, Stadtbergen (DE); Thomas SCHAEFER, Obermeitingen (DE); Peter HUFNAGEL, Pforzen (DE); Stefan HEROLD, München (DE)

(21) Appl. No.: 19/490,243

(22) PCT Filed: Jun. 6, 2024
(86) PCT No.: PCT/EP2024/065571

§ 371 Date: Dec. 4, 2025

(30) Foreign Application Priority Data
Jun. 23, 2023 (EP) 23181178.7

(51) Int. Cl. H02K 3/52; H02K 7/14

(52) U.S. Cl. CPC H02K 3/522; H02K 7/145; H02K 2203/09

(57) ABSTRACT

A clamping device for a stator of an electric motor, in particular as a drive for a power tool. A carrier element having a connection element and having at least one first and one second claw element is provided. A stator for an electric motor, which stator has at least one clamping device, which clamping device includes a carrier element having a connection element and having at least one first and one second claw element is also provided. A power tool having a stator for an electric motor, which stator includes at least one clamping device that has a carrier element having a connection element and having at least one first and one second claw element is also provided.

The present invention provides a clamping device for a stator of an electric motor, in particular as a drive for a power tool.

The present invention furthermore provides a stator for an electric motor, which stator has at least one clamping device.

The present invention furthermore provides a power tool having a stator for an electric motor.

### BACKGROUND

From the prior art, electric motors are known which comprise, inter alia, a stator and a rotor that is rotatable relative to the stator. For the functioning of the electric motor and in particular for the selective generation of a magnetic field, it is necessary for the stator to have a multiplicity of coil windings around the respective pole teeth or stator teeth. To produce a coil or coil winding, a winding wire is wound in multiple layers around the pole tooth or stator tooth. The pole tooth or stator tooth serves as a carrier for the coil winding.

Normally, the free ends of a winding wire are each contacted with or electrically energized by the so-called distributor rail. Clamps or clamping devices are used here to retain the free end of the winding wire and supply electrical energy thereto.

### SUMMARY OF THE INVENTION

Stators according to the prior art often have the problem that only a limited current intensity value (i.e. amperage) can be transmitted via the clamps or clamping devices to the wire windings. This prevents the electric motors from generating a particularly high level of power, i.e. in the form of a high rotational speed and/or a high torque.

It is an object of the present invention to solve the problem described above.

The present invention provides a clamping device for a stator of an electric motor, in particular as a drive for a power tool.

According to the invention, a carrier element having a connection element and having at least one first and one second claw element for respectively receiving a winding wire is provided.

In an alternative embodiment, it may be possible for each claw element to comprise an elastically deformable limb that can be set into a first or a second state, wherein, in the first state, the limb is undeformed and, in the second state, the limb has been deformed such that at least one winding wire is received and retained. A winding wire can thus be easily detachably connected to a claw element.

The “undeformed” state of the limb can also be understood as “open”.

It is also possible here for the carrier element to have more than one connection element and/or more than two claw elements for respectively receiving a winding wire.

In an alternative embodiment, it may be possible for the limb to have a length which, in a second state of the limb, can receive at least one first and one second winding wire with a cross-sectional area of between 1.5 and 2 mm² and in particular of 1.8 mm². A particularly high current intensity value can thus be transmitted.

In an alternative embodiment, it may be possible that, in a second state of the limb, a first portion at a first end of the limb lies parallel to and against a second portion at a second end of the limb, and a receiving space for a winding wire is formed between the first and the second end of the limb. Particularly secure closure of the limb and relatively secure retention of the winding wire can thus be achieved.

In an alternative embodiment, it may be possible for the clamping device to consist at least in part of a low-alloy copper alloy having a relatively low tin content and having relatively high electrical conductivity, in particular of CuSn0.15.

The invention further provides a stator for an electric motor, which stator has at least one clamping device comprising a carrier element having a connection element and having at least one first and one second claw element.

The invention further provides a power tool having a stator for an electric motor, which stator has at least one clamping device that comprises a carrier element having a connection element and having at least one first and one second claw element.

Further advantages will become apparent from the following description of the figures. Various exemplary embodiments of the present invention are illustrated in the figures.

### BRIEF DESCRIPTION OF THE DRAWINGS

The figures, the description and the claims comprise numerous features in combination. A person skilled in the art will expediently also consider the features individually and combine them to produce useful further combinations.

In the figures:

FIG. 1 shows a schematic side view of a power tool according to the invention according to an exemplary embodiment, having an electric motor;

FIG. 2 shows a perspective view of the electric motor having a stator and a rotor;

FIG. 3 shows a schematic plan view of a stator according to the invention according to an exemplary embodiment;

FIG. 4 shows a detail view of a clamping device according to the invention according to an exemplary embodiment with winding wires on the stator;

FIG. 5 shows a perspective plan view of the clamping device according to the invention that has a carrier element having a connection element and having a first and a second claw element; and

FIG. 6 shows a detail view of the first claw element with a first and a second winding wire.

### DETAILED DESCRIPTION

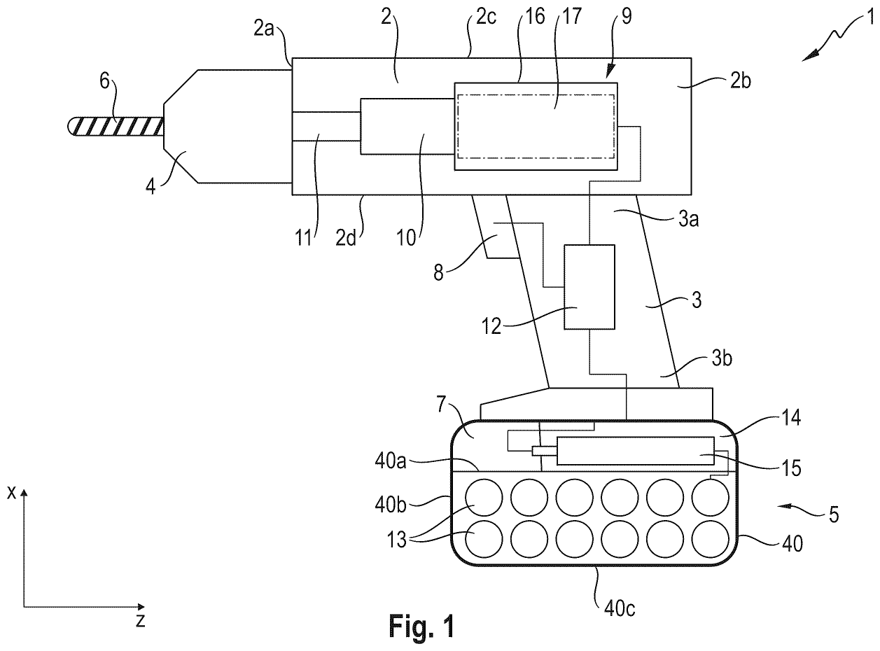

FIG. 1 shows a power tool 1 according to an exemplary embodiment. The power tool 1 is in the form of a rechargeable-battery-powered power drill.

According to an alternative exemplary embodiment, the power tool may also be in the form of a saw, a grinder, a hammer drill or the like.

The power tool 1 in the form of a power drill comprises substantially a housing 2, a handle 3, a tool fitting 4 and a power supply 5.

The housing 2 has a front end 2a, a rear end 2b, an upper end 2c and a lower end 2d.

The tool fitting 4 is positioned at the front end 2a of the housing 2. The tool fitting 4 serves to receive and retain a tool 6.

In the present exemplary embodiment, the tool 6 is in the form of a drill bit. A first end 3a of the handle 3 is positioned at the lower end 2d of the housing 2. A rechargeable-battery interface 7 is provided at the second end 3b of the handle 3.

As shown in FIG. 1, the handle 3 has an activation switch 8 by means of which the power tool 1 can be set into an activated state or a deactivated state.

The power supply 5 can be detachably fastened to the rechargeable-battery interface 7. In the present exemplary embodiment, the power supply 5 is in the form of a rechargeable battery. The power supply 5 serves to supply electrical energy to the power tool.

In an alternative exemplary embodiment, the power supply 5 may also be in the form of an electrical cable for connecting the power tool 1 to a main power source (electrical socket).

Primarily a drive 9, a transmission device 10, a drive shaft 11 and a control device 12 are positioned in the interior of the housing 2.

The drive 9, the transmission device 10, the drive shaft 11 and the tool fitting 4 are arranged relative to one another in the interior of the housing 2 such that a torque generated in the drive 9 can be transmitted to the transmission device 10, the drive shaft 11 and ultimately to the tool fitting 4 or to the tool 6.

The control device 12 is connected via corresponding lines 13 to the activation switch 8, the rechargeable-battery interface 7 and the drive 9.

The power supply 5 in the form of a rechargeable battery can be detachably connected to the power tool 1 in order to supply the power tool 1 with electrical energy. The rechargeable battery 5 substantially comprises a rechargeable-battery housing 40, a number of energy storage cells 13, a rechargeable-battery interface 14, and a control device 15.

The energy storage cells 13 may also be referred to as rechargeable-battery cells and are arranged in the interior of the rechargeable-battery housing 40.

The rechargeable-battery housing 40 substantially comprises a cover element 40a, four side walls 40b, and a base element 40c.

The rechargeable-battery interface 14 is arranged on the outer side of the cover element 40a and serves to electrically or electronically connect, as well as mechanically connect, the rechargeable battery 5 to the power tool 1 or to a charging device.

The charging device is used to charge the rechargeable battery 5 with electrical energy.

For the purposes of electrical or electronic connection, the rechargeable-battery interface 14 has a positive contact, a negative contact, and a communication contact. The positive contact and negative contact serve to produce an electrical circuit when the rechargeable battery 5 is connected to a power tool 1 or to a charging device. The communication contact serves to send and receive data and information in the form of electrical signals.

Alternatively or in addition, the rechargeable battery 5 may also include a means for radio communication (e.g. Bluetooth) or wireless communication.

The energy storage cells 13 serve to receive, store, and re-deliver electrical energy. The energy storage cells 13 are of cylindrical form and are based on lithium-ion technology. Each energy storage cell 13 contains, at one end, a contact device which serves for the transmission of electrical energy. The individual contact devices are connected via corresponding lines to the control device 15 of the rechargeable battery 5.

Alternatively, the energy storage cells 13 can also be based on another suitable technology.

The cylindrical shape of the energy storage cells 13 is likewise optional, so any other suitable shape or geometry may also be selected. It is thus in particular also possible that the energy storage cells 13 are configured as pouch cells.

It is additionally also possible that the rechargeable battery 5 contains both cylindrical energy storage cells 13 and pouch cells. It is in particular possible that the rechargeable battery 5 contains only a single cylindrical energy storage cell 13 and a single pouch cell.

The control device 15 controls the different functions of the rechargeable battery 5 in a closed-loop and open-loop manner. The functions include, inter alia, controlling the receipt and delivery of electrical energy into and from the energy storage cells 13. Furthermore, the control device 15 is also used to control the amount of electrical energy that is to be received or delivered by the energy storage cells 13.

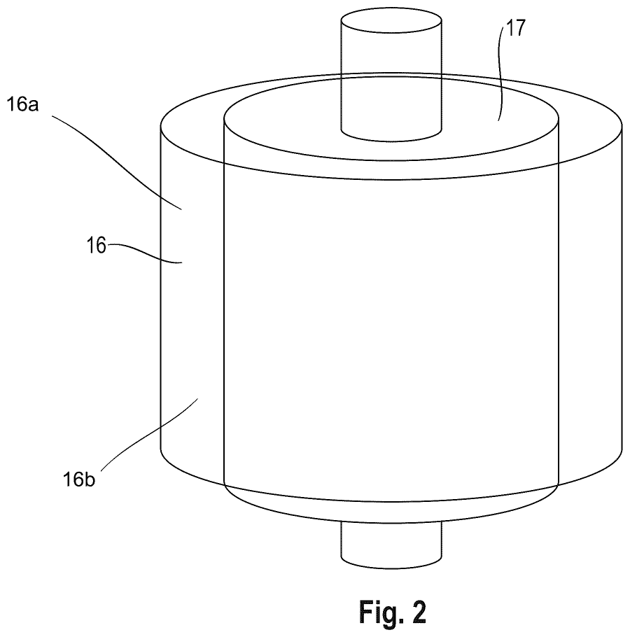

The drive 9 is in the form of a brushless electric motor and comprises substantially a stator 16 and a rotor 17; cf. FIG. 2.

Here, the rotor 17 is positioned in the interior of the stator 16 and is also designed to be rotatable relative to the stator 16.

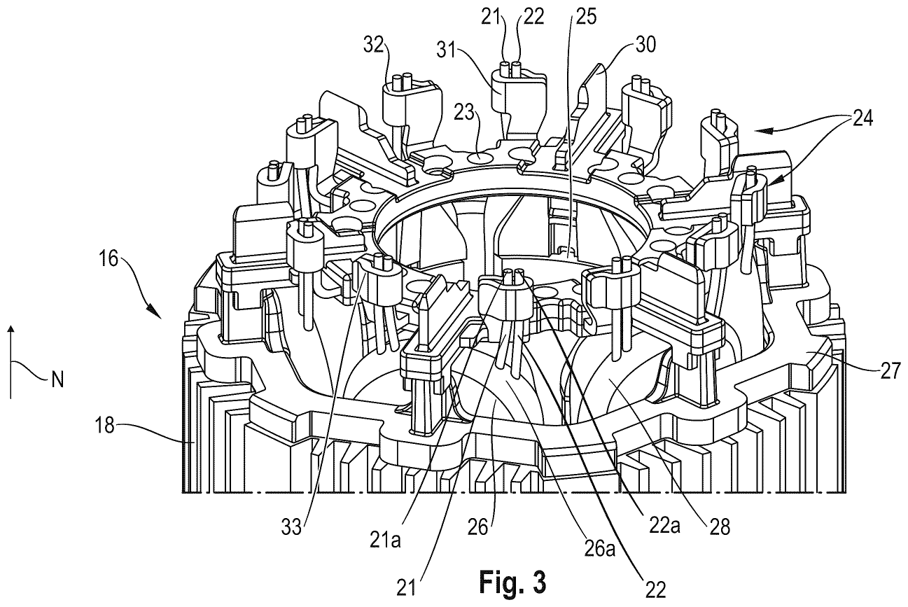

FIG. 3 shows an upper end 16a of the stator 16 according to an exemplary embodiment. A lower end 16b of the stator 16 is situated opposite the upper end 16a (see, e.g., FIG. 2).

The stator 16 that is illustrated by way of example in the figures comprises a laminated core 18, a winding support 27, six coils 26, a collecting unit 23 and six clamping devices 24, each of the coils having a first and a second winding wire 21, 22. The coil 26 can in this case also be referred to as a winding coil.

The electric motor 9 shown in the figures is designed here as a synchronous three-phase motor, wherein the winding wires 21, 22 (also referred to as power wires) implement the U phase, V phase and W phase.

The laminated core 18 consists substantially of a number of profiled laminations stacked one on top of the other. As is merely indicated in FIG. 3, six pole teeth 25 extend to the middle of the laminated core 18. In each case one first and one second winding wire 21, 22 is wound around each individual pole tooth 25 in order to form a coil 26. A winding support 27 is arranged at each of the ends 16a, 16b of the stator 16 in order to support or retain the coil 26 that is formed from the winding wires 21, 22 by winding. FIG. 3 shows the upper end 16a of the stator 16 with a winding support 27.

The coils 26 or the first and the second winding wire 21, 22 are coated with a plastic material 28 that serves to insulate the coil 26. At the upper end 26a of each coil 26, a free end 21a, 22a of the first and of the second winding wire 21, 22 projects out of the insulating plastics material 28. The free ends 21a, 22a of the first and of the second winding wire 21, 22 thus extend in the direction N.

The collecting unit 23 is arranged above the winding support 27 in the direction N and serves substantially for retaining and positioning the six clamping devices 24. The clamping devices 24 in turn serve for receiving and retaining the free ends 21a, 22a of the first and of the second winding wire 21, 22. Furthermore, the clamping devices 24 serve as a connection means for the power supply or the supply of electrical energy to the winding wires 21, 22 for the purposes of generating the U phase, V phase and W phase during the operation of the drive 9 in the form of an electric motor.

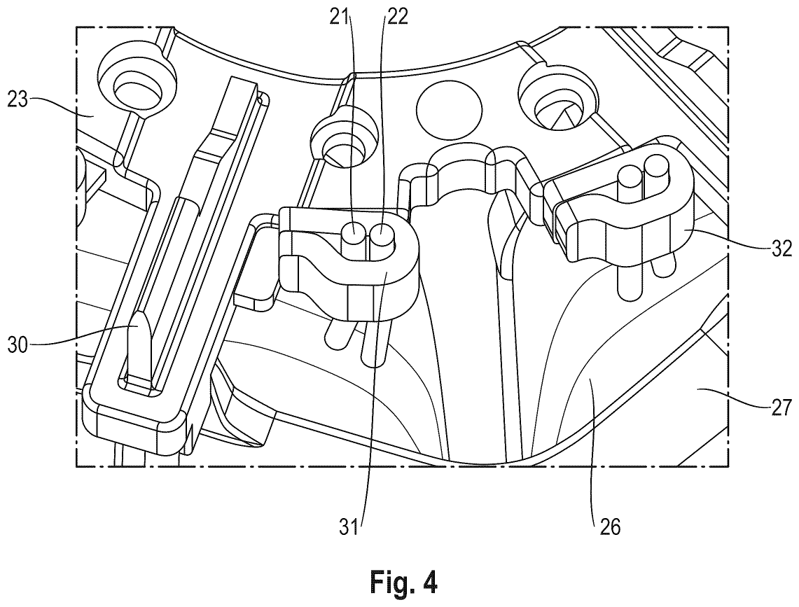

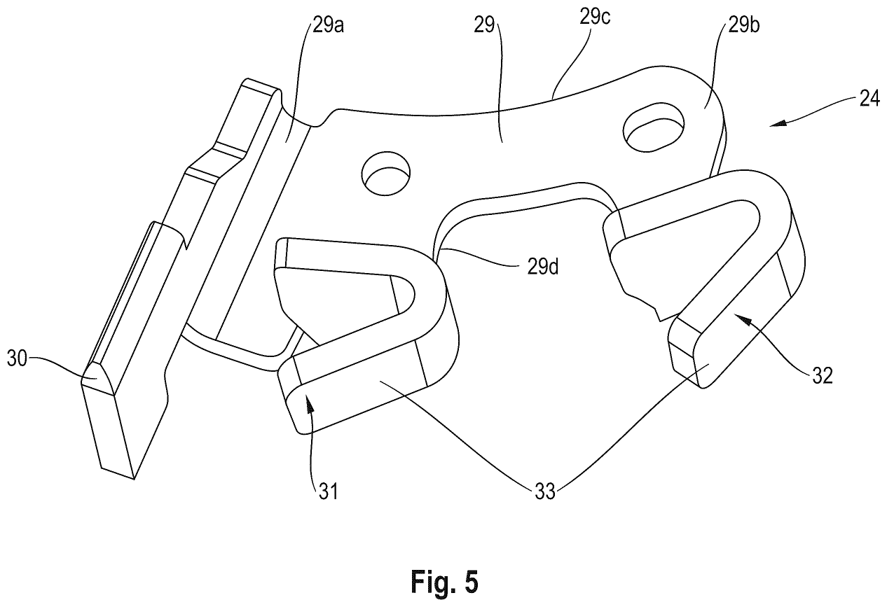

As shown in FIGS. 4 and 5, each clamping device 24 comprises a carrier element 29 having a connection element 30 and having a first and a second claw element 31, 32.

As shown in particular in FIG. 5, the carrier element 29 is substantially in the form of an elongate base plate. The carrier element 29 in the form of an elongate base plate has a first end 29a and a second end 29b and has an upper edge 29c and a lower edge 29d. The connection element 30 is positioned at the first end 29a of the carrier element 29. The connection element 30 serves as a connection point for a line for power supply purposes.

The first claw element 31 is positioned at the lower edge 29d of the carrier element 29. The second claw element 32 is positioned in the vicinity of the second end 29b of the carrier element 29.

Each claw element 31, 32 comprises an elastically deformable limb 33 that can be set into a first or a second state.

In the first state, the limb 33 is undeformed or open, cf. FIG. 5. In the second state, the limb 33 has been deformed such that the first and the second winding wire 21, 22 can be received and retained, cf. FIGS. 3 and 4.

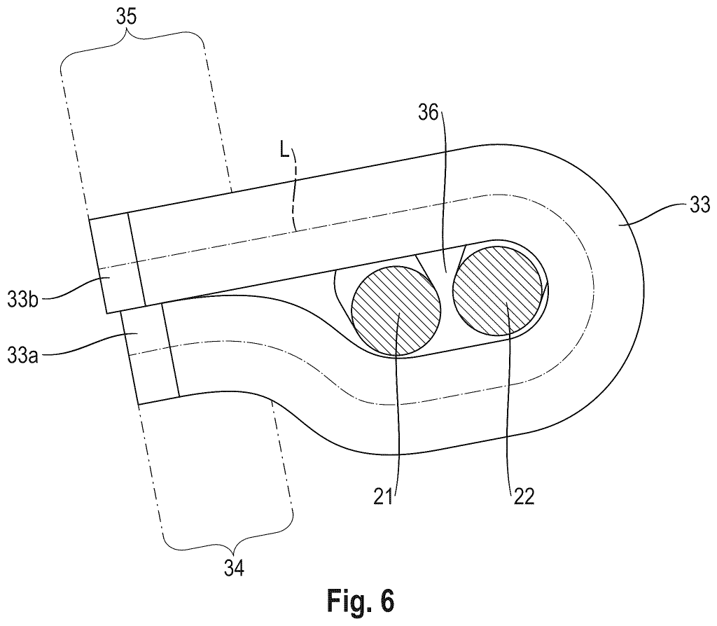

FIG. 6 shows a limb 33 of a claw element 31, 32 in a second state or in a deformed situation, such that the first and the second winding wire 21, 22 are retained by the limb 33 of the claw element 31, 32.

In particular, the limb 33 has a length L such that, in the second state, i.e. the deformed state, of the limb 33, the first and the second winding wire 21, 22 with a cross-sectional area of between 1.5 and 2 mm², and in particular of 1.8 mm², can be received.

As illustrated in FIG. 6, in the second state, i.e. the deformed state, of the limb 33, a first (free) portion 34 at a first end 33a of the limb 33 lies substantially parallel to and against a second portion 35 at a second end 33b of the limb 33. A receiving space 36 for the first and the second winding wire 21, 22 is thus formed between the first end 33a and the second end 33b of the limb 33.

The clamping device 24 consists at least in part of a low-alloy copper alloy having a relatively low tin content and having relatively high electrical conductivity, in particular of CuSn0.15.

### LIST OF REFERENCE SIGNS

1 Power tool
2 Housing
2a Front end of the housing
2b Rear end of the housing
2c Upper end of the housing
2d Lower end of the housing
3 Handle
3a First end of the handle
3b Second end of the handle
4 Tool fitting
5 Power supply
6 Tool
7 Rechargeable-battery interface
8 Activation switch
9 Drive
10 Transmission device
11 Drive shaft
12 Control device
13 Energy storage cell
14 Rechargeable-battery interface
15 Control device
16 Stator
16a Upper end of the stator
16b Lower end of the stator
17 Rotor
18 Laminated core
21 First winding wire
21a Free end
22 Second winding wire
22a Free end
23 Collecting unit
24 Clamping device
25 Pole tooth
26 Coil
26a Upper end of the coil
27 Winding support
28 Plastics material
29 Carrier element
29a First end of the carrier element
29b Second end of the carrier element
29c Upper edge of the carrier element
29d Lower edge of the carrier element
30 Connection element
31 First claw element
32 Second claw element
33 Limb
33a First end of the limb
33b Second end of the limb
34 First portion of the limb
35 Second portion of the limb
36 Receiving space
40 Rechargeable-battery housing
40a Cover element of the rechargeable-battery housing
40b Side wall of the rechargeable-battery housing
40c Base element of the rechargeable-battery housing
L Length of the limb

What is claimed is:

1.- 7. (canceled)

8: A clamping device for a stator of an electric motor, the clamping device comprising:
a carrier having a connector and having at least one first and one second claw for respectively receiving at least one winding wire.

9: The clamping device as recited in claim 8 wherein each of the claws includes an elastically deformable limb settable into a first or a second state, wherein, in the first state, the limb is open and, in the second state, the limb has been deformed such that at least one winding wire is received and retained.

10: The clamping device as recited in claim 8 wherein the limb has a length in a second state of the limb capable of receiving a first and a second winding wire of the at least one winding wire with a cross-sectional area of between 1.5 and 2 mm².

11: The clamping device as recited in claim 10 wherein the limb receives the first and second winding wires each with a cross-sectional area of 1.8 mm².

12: The clamping device as recited in claim 8 wherein in a second state of the limb, a first portion at a first end of the limb lies parallel to and against a second portion at a second end of the limb, and a receiving space for the at least one winding wire is formed between the first and the second end of the limb.

13: The clamping device as recited in claim 8 wherein the clamping device includes a tin-copper alloy.

14: The clamping device as recited in claim 13 wherein the tin-copper alloy is CuSn0.15.

15: A stator for an electric motor comprising the clamping device as recited in claim 8.

16: A power tool comprising the stator as recited in claim 15.

17: A drive for a power tool comprising the clamping device as recited in claim 8.
